(19) United States
(12) Patent Application Publication
(10) Pub. No.: US 2009/0178134 A1
(43) Pub. Date: Jul. 9, 2009

(54) SYSTEM AND METHOD FOR BLOCKING INTERNET ACCESS AND/OR APPLICATIONS

(76) Inventor: RONALD J. DEHAAS, Owosso, MI (US)

Correspondence Address: DICKINSON WRIGHT PLLC, 1875 Eye Street, NW, Suite 1200, WASHINGTON, DC, 20006, US

(21) Appl. No.: 11/969,378

(22) Filed: Jan. 4, 2008

(51) Int. Cl. G06F 21/00

(52) U.S. Cl. 726/17

(57) ABSTRACT

The present invention generally relates to a system and method for selectively blocking computer application access and, specifically, to a system and method for blocking Internet access and/or applications when a specified string of characters is entered from a keyboard or other input device. Specifically in one embodiment is provided a system for selectively blocking computer application access of a selected user, which includes a blocking program configured to monitor keystrokes of said user, a predefined database of keystrokes, the program continuously monitoring said user keystrokes and comparing them to said database of keystrokes, and a predefined action when said user keystrokes match said database keystrokes. The predefined action can be to block Internet access or terminate an Internet connection, or Internet protocol, or computer application.

### CROSS REFERENCE TO RELATED APPLICATIONS

None.

### FIELD OF THE INVENTION

The present invention generally relates to a system and method for blocking computer application access and, specifically, to a system and method for blocking Internet access and/or applications when a specified string of characters is entered from a keyboard or other input device.

### BACKGROUND OF THE INVENTION

Although it would be desirable or even necessary to block access to selectable or objectionable material from some users in web sites and the like, this is often not possible as a practical matter. Such blocking may either compulsorily or voluntarily monitor the usage of a selected computer or, in some cases televisions, and compile a record of the web sites or channels accessed by that particular user. This record could be made available to select third party recipients automatically and at predetermined time intervals, or access to the record may be provided to the selected third party recipient.

Site-specific internet usage monitoring programs are also generally known in the art. Such monitoring programs may be installed by employers or parents to monitor the web sites visited by employees or children, respectively. It may also be desirable to monitor web sites accessed by other persons under a variety of different circumstances. Involuntary applications of these types of programs are often used by employers. The employee has no choice but to accept the monitoring activity on the computer since they have no expectation of privacy for business-owned systems. In a voluntary monitoring system, the Administrator knowingly and voluntarily has the monitoring program installed on a particular computer to monitor his internet activities. The Administrator may even select one or more third party recipients to receive, or have access to, a report containing a record of the internet activity of the computer user.

For example, U.S. Pat. No. 6,606,657 to Zilbertstein, et al., describes a system to gather and report detailed information on a user's web site visitation. Here, a server system is connected to the internet and receives, processes, and supplies detailed user information such as the sites visited and the duration and times of such visits. Such information is gathered and transmitted to subscribers who have reporting and communicating software installed. In addition, the users submit profile information about themselves. Demographic information as to the popularity of visited web sites may then be easily determined, stored, and updated by the server. This demographic information, in turn, may be provided to other users or web site operators and advertisers. The invention disclosed also allows users to initiate chat sessions with other users visiting a particular web site or post a virtual note on the site for other subscribers to read. A disadvantage to this invention is that most of the web monitoring information is provided to the website owners and operators, not the users.

Further, there are computer programs known in the art to block access to the Internet. There are also programs known in the art to allow the capturing of keyboard entries, such that all typing on a keyboard (or other equivalent input device) can be stored for potential monitoring and/or filtering. However, combining these types of programs is unknown in the art. There is a need for providing a computer application that allows an Administrator to specify a string of characters (for instance, a home address or telephone number) and, when that string of characters is entered, the same software would block access to specified protocols or would terminate the Internet connection altogether.

### SUMMARY OF THE INVENTION

Accordingly, the present invention provides a system and method for blocking computer application access and, specifically, to a system and method for blocking Internet access and/or applications when a specified string of characters is entered from a keyboard or other input device.

Specifically in one embodiment is provided a system for selectively blocking computer application access of a selected user, which includes a blocking program configured to monitor keystrokes of said user, a predefined database of keystrokes, the program continuously monitoring said user keystrokes and comparing them to said database of keystrokes, and a predefined action when said user keystrokes match said database keystrokes. The predefined action can be to block access to specified Internet protocols, or terminate an Internet connection, or terminate specified computer applications.

The present invention may be practiced using a database stored internally on the computer or on a server to which the user is communicatively connected.

Editing of the database and actions are possible by pre-selected Administrators, and other Administrators, may be provided notification that the database or actions have been changed.

Actions can vary based on the application and may be suspended in predefined time or day intervals.

Other features of the present invention will become more apparent to persons having ordinary skill in the art to which the present invention pertains from the following description and claims.

### BRIEF DESCRIPTION OF THE DRAWINGS

The foregoing features, as well as other features, will become apparent with reference to the description and figure below, in which like numerals represent elements and in which:

FIG. 1 illustrates a schematic representation of a blocking system of the present invention.

### DETAILED DESCRIPTION OF THE PREFERRED EMBODIMENT

The present invention generally relates to a system and method for blocking computer application access and/or access to Internet protocols, and specifically, to a system and method for blocking Internet access and/or applications when a specified string of characters is entered from a keyboard or other input device. The present invention is developed in the same art as has been previously filed by the present inventor (namely US Publication Nos: 20070061869 Access of Internet use for a selected user; 20070022296 Electronic data registry and certification system and method; and 20050108383 Internet Use Monitoring System and Method), the contents of which are herein incorporated in their entirety.

The present invention system for blocking computer application access can include various computer applications that can not only block internet access, but can also block access to other programs or other computer applications as well when a specified string of characters is entered from a keyboard or other input device. The blocking itself can be pre-selected as well including day, date, and time selections.

In general, the present invention can be realized as methods or systems in hardware, software, or a combination of hardware and software of a computer system, including a computer network system which may include the Internet. The present invention can be realized in a centralized fashion in one computer system or in a distributed fashion, where different elements are spread across several computer systems. Any kind of computer system or other apparatus adapted for carrying out the methods described herein is suited. A typical combination of hardware and software may include a general purpose computer system with a computer program that, when being loaded and executed, controls the computer system such that it carries out the systems and methods described herein. The present invention may also be voluntarily embedded in a computer program product (or any computer useable medium having computer readable program code embodied therein) which comprises all the features enabling the implementation of the methods and systems described herein and which, when loaded in a computer system, is able to carry out these systems and methods.

Computer program or computer program product, in the present context, means any expression, in any language, code, or notation, of a set of instructions intended to cause a system having an information processing capability to perform a particular function, either directly or after either or both of the following: (a) conversion to another language, code, or notation; and (b) reproduction in a different material or electronic form. The term “User” as used herein can refer to a person or persons who is using a computing device, such as a computer, PDA, cell phone, or the like. The term “Administrator” is used herein can refer to a person or persons who are authorized and have the ability to install and/or activate the blocking application provided in the claims.

The system and method of the present invention can have a computer Administrator install a program on a computer device (such as a desktop, laptop, cell phone, personal digital assistant (PDA), etc.) which: (1) permits the Administrator to specify a string of keystrokes or other specified input characters; (2) permits the Administrator to specify Internet protocols that may be blocked by the software; and (3) when that specified string of keystrokes or other specified input characters is entered, blocks said computer from Internet access through said specified Internet protocols.

The system and method can block any or all Internet protocols by terminating the Internet connection. The specified string of keystrokes or other specified input characters can be stored internally on said computer. The computer can have a secure means (such as password protection) to edit the string of keystrokes or other specified input characters. When a string of keystrokes or other specified input characters are entered, the computer Administrator can be notified by telephone, email, or other electronic means. The computer Administrator can provide, for himself or other desired users, a means of overriding said blocking of computer applications or protocols or termination of Internet connection. The system and method may be configured to the predefined constraints to specified time ranges throughout the day. The time constraints can be configured to be different on different days, as specified. The computer device can have the program preinstalled and activated by a computer Administrator.

In one embodiment, a computer Administrator would install a program on a computer device (such as a desktop, laptop, cell phone, PDA, etc.) which: (1) permits the Administrator to specify a string of keystrokes or other specified input characters; (2) permits the Administrator to specify computer programs and applications that may be disabled by the software; and (3) when that specified string of keystrokes or other specified input characters is entered, blocks said computer from using said programs.

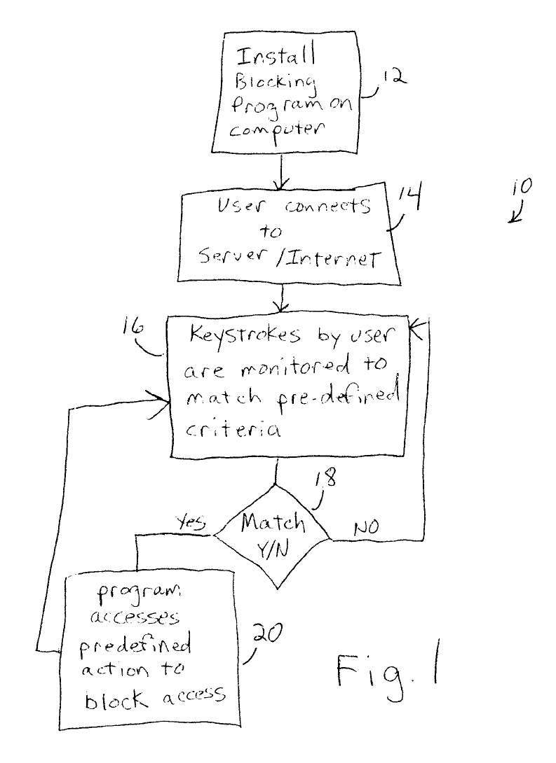

Referring now to FIG. 1, shown is a schematic representation of one embodiment of a blocking system of the present invention and is generally indicated at 10. As shown, the application may be installed at 12 on a host computer or may reside in a server within a network and may be voluntary or involuntary and known or unknown by a user. A user can then connect to the Internet at 14 (or whatever application has been predefined to monitor). Once the application, such as the Internet, has been accessed, the system monitors keystrokes to match the predefined criteria at step 16. If no keystrokes match the predefined criteria at step 18, the system maintains monitoring without blocking. If at step 18 a keystroke string is matched, then the system takes the action predefined at step 20. In one embodiment of the present invention, this would block further access to the application (such as the Internet). The system could be designed to be flexible to block specific computer applications, Internet protocols, or all Internet access. Alternatively, it could disconnect internet access altogether or even block further use of the computer or other programs associated with the computer.

The present invention can be a voluntary or involuntary Internet monitoring system and method for monitoring, recording, and blocking Internet use of a particular computer user including web browsing activity, file sharing program access, news group access, chat room activity, file transfer programs access, e-mails sent and received, and the like and providing a report to a third party recipient, who may also be an Administrator. This type of monitoring and blocking, when voluntarily initiated, may provide an Administrator a method to minimize temptations to engage in Internet access activities considered objectionable to the Administrator.

System 10 of the present invention can provide a system of blocking Internet access activity of a computer user and includes a selected computer onto which the program can be installed. The Administrator may voluntarily elect to have the program installed on his computer to block his own Internet access activities. Or the program may be installed involuntarily and even without the knowledge of the user. The system may also allow selection of one or more third party recipients who will receive reports or have access to reports of the blocked Internet activity of the user.

The program of the present invention may be installed by downloading the program directly from a remote server through an Internet connection or other suitable means or may, alternatively, be installed manually by way of a prerecorded media, such as a compact disc (CD), or it may be pre-installed as hardware or software by a computer manufacturer or retailer. Before installing the monitoring program, or activating the pre-installed monitoring program, the Administrator (or installer) may make certain pre-installation or pre-activation elections, such as what information (keystrokes) to monitor and even who will be the recipient of information gathered with the monitoring program, how often reports will be updated and made available to either the Administrator or a third party recipient, as well as other key parameters such as time intervals, time of day, specific days, and the like.

In one embodiment, the program may reside on a separate server. Once the blocking program has been installed on a computer, the computer may be communicatively connected to a server through an electronic connection such as telephone lines, cable, fiber optics, electric power lines, or other suitable connection. When the user attempts to connect to the Internet, the user will be unable to gain access to the Internet without first establishing a connection with a remote server. During or after the initial installation of the blocking program, the Administrator may elect to have an automatic connection to the remote server and thus, the Internet, or may have a prompt display on the screen of the computer indicating that a password is required to enter the Internet. This password would then connect the computer to the remote server. The remote server may include any personal computer or other hardware system available and known in the art. The server may be a single server or include a “server cluster” containing multiple servers.

When the blocking program is installed, during any given session of Internet access, all Internet access activity of the user can be monitored and optionally recorded by the monitoring program onto the remote server or on the computer itself. The type of Internet protocols accessed are not critical, in that only keystrokes are recorded and monitored.

In embodiments where blocked information or keystrokes are stored, specified Administrators may retrieve reported information either from the computer or remote server through an Internet connection. Alternatively, an electronic message (e.g., e-mail, facsimile) may be sent automatically to the third party recipient and/or Administrator with a reminder to access the remote server to check the report. Thus, the third party recipient and/or Administrator may receive reports and other information from the remote server or may access the remote server to view or request reports and other information. Another optional communication between the remote server and the third party recipient may include sending the recipient a notice when the Administrator has deleted that third party from the recipient list. Since the system is designed for voluntary monitoring, the Administrator may elect at any time to delete, add, or replace third party recipients.

The description of the present invention herein is presented to enable any person skilled in the art to make and use the invention and is provided in the context of particular applications of the invention and their requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

I claim:

1. A system for selectively blocking computer application access of a selected user, comprising:
a blocking program, the blocking program configured to monitor keystrokes of said user;
a predefined database of keystrokes;
the program continuously monitoring said user keystrokes and comparing them to said database of keystrokes; and
a predefined action when said user keystrokes match said database keystrokes, wherein said predefined action blocks access to the computer application.

2. The system of claim 1, wherein said predefined action is to block Internet access.

3. The system of claim 2, wherein said predefined action to block Internet access is by terminating an Internet connection.

4. The system of claim 1, wherein said predefined database of keystrokes is stored internally on said computer.

5. The system of claim 1, further comprising a secure means to edit said database of keystrokes.

6. The system of claim 1, further comprising notification to a Administrator that said database of keystrokes has been edited.

7. The system of claim 1, further comprising an override of said predefined action to pre-selected users.

8. The system of claim 1, further comprising a timer to suspend predefined action.

9. The system of claim 8, wherein said time is limited to suspend predefined actions by predefined days.

10. The system of claim 1, wherein said predefined action is to terminate a software application.

11. A system and method wherein a computer Administrator would install a program on a computer device (such as a desktop, laptop, cell phone, PDA, etc.) which: (1) permits the Administrator to specify a string of keystrokes or other specified input characters; (2) permits the Administrator to specify Internet protocols that may be blocked by the software; and (3) when that specified string of keystrokes or other specified input characters is entered, blocks said computer from Internet access through said specified Internet protocols.

12. The system and method of claim 11, wherein all Internet protocols are blocked by terminating the Internet connection.

13. The system and method of claim 11, wherein said specified string of keystrokes or other specified input characters are stored internally on said computer.

14. The system and method of claim 11, wherein said computer Administrator has secure means (such as password protection) to edit the string of keystrokes or other specified input characters.

15. The system and method of claim 11, wherein when said string of keystrokes or other specified input characters are entered, said computer user is notified by telephone, email, or other electronic means.

16. The system and method of claim 11, wherein said computer Administrator may provide, for himself or other desired users, a means of overriding said blocking of protocols or termination of Internet connection.

17. The system and method of claim 11, wherein said constraints are limited to specified time ranges throughout the day.

18. The system and method of claim 17, wherein specified time ranges may be different on different days, as specified.

19. The system and method of claim 11, wherein said computer device would have said program preinstalled and activated by said computer Administrator.
